(19) United States
(12) Patent Application Publication
(10) Pub. No.: US 2024/0255714 A1
(43) Pub. Date: Aug. 1, 2024

(54) SEMICONDUCTOR DEVICE AND MANUFACTURING METHOD OF SEMICONDUCTOR DEVICE

(71) Applicant: InnoLux Corporation, Miao-Li County (TW)

(72) Inventors: Cheng-Chi WANG, Miao-Li County (TW); Jui-Jen YUEH, Miao-Li County (TW)

(73) Assignee: InnoLux Corporation, Miao-Li County (TW)

(21) Appl. No.: 18/409,730

(22) Filed: Jan. 10, 2024

Related U.S. Application Data
(60) Provisional application No. 63/442,108, filed on Jan. 30, 2023.

(30) Foreign Application Priority Data
Sep. 26, 2023 (CN) 202311246332.3

(51) Int. Cl. G02B 6/42

(52) U.S. Cl. CPC G02B 6/423; G02B 6/4259; G02B 6/4283; G02B 6/4295

(57) ABSTRACT

The present disclosure provides a semiconductor device, including a substrate structure, a photonic unit, an optical fiber and a chip unit. The substrate structure includes a coupling member. The photonic unit is disposed in a first recess of the coupling member. The optical fiber is disposed in a second recess of the coupling member and optically coupled to the photonic unit. The chip unit is disposed on the substrate structure and electrically connected to the photonic unit through the coupling member. A depth of the second recess is greater than or equal to half a diameter of the optical fiber.

### CROSS REFERENCE TO RELATED APPLICATION

This application claims the benefit of U.S. Provisional Application No. 63/442,108, filed on Jan. 30, 2023. The content of the application is incorporated herein by reference.

### BACKGROUND OF THE DISCLOSURE

### 1. Field of the Disclosure

The present disclosure relates to a semiconductor device, and particularly to a semiconductor device with an optical fiber and a chip unit integrated therein. The present disclosure also relates to a manufacturing method of a semiconductor device, and particularly to a manufacturing method of a semiconductor device with an optical fiber and a chip unit integrated therein.

### 2. Description of the Prior Art

With the increasing requirement on data transmission efficiency of a data center, technologies relevant to semiconductor devices have been developed to integrate an optical module for transmitting or receiving light signals with a semiconductor chip on a circuit board to form a photonic system. However, shortcomings such as undesirably large size and thickness still exist in the current photonic system. In addition, the optical module of the current photonic system still needs to be electrically connected to the semiconductor chip through a printed circuit board (PCB), which leads to high power consumption and poor operation efficiency.

### SUMMARY OF THE DISCLOSURE

According to an embodiment of the present disclosure, a semiconductor device is provided. The semiconductor device includes a substrate structure, a photonic unit, an optical fiber and a chip unit. The substrate structure includes a coupling member. The photonic unit is disposed in a first recess of the coupling member. The optical fiber is disposed in a second recess of the coupling member and optically coupled to the photonic unit. The chip unit is disposed on the substrate structure and electrically connected to the photonic unit through the coupling member. A depth of the second recess is greater than or equal to half a diameter of the optical fiber.

According to another embodiment of the present disclosure, a manufacturing method of a semiconductor device is provided. The manufacturing method of the semiconductor device includes forming a substrate structure and a photonic unit, wherein the substrate structure includes a coupling member, and the photonic unit is disposed in a first recess of the coupling member; disposing a chip unit on the substrate structure, wherein the chip unit is electrically connected to the photonic unit through the coupling member; and disposing an optical fiber in a second recess of the coupling member, wherein the optical fiber is optically coupled to the photonic unit. A depth of the second recess is greater than or equal to half a diameter of the optical fiber.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 schematically illustrates a top view of a semiconductor device according to a first embodiment of the present disclosure.

FIG. 2 schematically illustrates a cross-sectional view taken along a section line A-A′ of FIG. 1.

FIG. 3 schematically illustrates a cross-sectional view taken along a section line B-B′ of FIG. 1.

FIG. 4 schematically illustrates a cross-sectional view of a substrate structure and optical fibers according to a variant embodiment of the first embodiment of the present disclosure.

FIG. 5 to FIG. 8 are schematic diagrams illustrating cross-sectional views of structures in different steps of manufacturing the semiconductor device according to the first embodiment of the present disclosure, respectively.

FIG. 9 schematically illustrates a cross-sectional view of a semiconductor device according to a second embodiment of the present disclosure.

FIG. 10 to FIG. 12 are schematic diagrams illustrating cross-sectional views illustrating structures in different steps of manufacturing the semiconductor device according to the second embodiment of the present disclosure, respectively.

### DETAILED DESCRIPTION

The contents of the present disclosure will be described in detail with reference to specific embodiments and drawings. It is noted that, for purposes of illustrative clarity and being easily understood by the readers, the following drawings may be simplified schematic diagrams, and elements therein may not be drawn to scale. The numbers and sizes of the elements in the drawings are just illustrative and are not intended to limit the scope of the present disclosure.

Certain terms are used throughout the specification and the appended claims of the present disclosure to refer to specific elements. Those skilled in the art should understand that electronic equipment manufacturers may refer to an element by different names, and this document does not intend to distinguish between elements that differ in name but not function. In the following description and claims, the terms “comprise”, “include” and “have” are open-ended fashion, so they should be interpreted as “including but not limited to . . . ”.

The ordinal numbers used in the specification and the appended claims, such as “first”, “second”, etc., are used to describe the elements of the claims. It does not mean that the element has any previous ordinal numbers, nor does it represent the order of a certain element and another element, or the sequence in a manufacturing method. These ordinal numbers are just used to make a claimed element with a certain name be clearly distinguishable from another claimed element with the same name.

In addition, when one element or layer is “connected to” the another element or layer, it may be understood that the element or layer is directly connected to the another element or layer, and alternatively, the element or layer is (indirectly) electrically connected to the another element or layer through another element or layer. On the contrary, when the element or layer is “directly electrically connected to” the another element or layer, it may be understood that there is no intervening element or layer connected between the element or layer and the another element or layer. Also, the term “electrically connected” or “coupled” includes means of direct or indirect electrical connection.

As disclosed herein, the terms “approximately”, “essentially”, “about”, or “substantially” generally mean within 10%, 5%, 3%, 2%, 1%, or 0.5% of the reported numerical value or range. The quantity disclosed herein is an approximate quantity, that is, without a specific description of “approximately”, “essentially”, “about”, or “substantially”, the quantity may still include the meaning of “approximately”, “essentially”, “about”, or “substantially”.

The term “ranged from a value A to a value B” is interpreted as including the value A and the value B or at least one of the value A or the value B, and including other values between the value A and value B.

In the present disclosure, the depth, thickness, length, and width may be measured by using an optical microscope (OM), and the depth, the thickness or the width may be measured from a cross-sectional image in a scanning electron microscope (SEM), but not limited thereto.

It should be understood that according to the following embodiments, features of different embodiments may be replaced, recombined, or mixed to constitute other embodiments without departing from the spirit of the present disclosure. The features of various embodiments may be mixed arbitrarily and used in different embodiments without departing from the spirit of the present disclosure or conflicting.

Unless otherwise defined, all terms (including technical and scientific terms) used herein have the same meaning as commonly understood by those skilled in the art. It should be understood that these terms, such as those defined in commonly used dictionaries, should be interpreted as having meaning consistent with the relevant technology and the background or context of the present disclosure, and should not be interpreted in an idealized or excessively formal way, unless there is a special definition in the embodiments of the present disclosure.

A semiconductor device of the present disclosure may be applied to any electronic device. The electronic device may include, for example, a display device, a light emitting device, a sensing device, an antenna device, a touch device, a tiled device, a packaging device or any other suitable electronic device, but it is not limited thereto. The electronic device may be, for example, a bendable, stretchable, foldable, rollable and/or flexible electronic device, but it is not limited thereto. The display device may be applied to, for example, notebooks, public displays, tiled displays, car displays, touch displays, televisions, monitors, smart phones, tablets, light source modules, lighting equipment, military equipment or electronic devices applied to the above products, but it is not limited to this. The sensing device may be, for example, a sensing device for detecting capacitance change, light, heat energy or ultrasonic waves, but it is not limited thereto. The sensing device may, for example, include a biosensor, a touch sensor, a fingerprint sensor, other suitable sensors or a combination of the above types of sensors. The display device may include, for example, liquid crystal molecules, light emitting diodes, fluorescent material, phosphor material, other suitable display media, or combinations thereof, but it is not limited thereto. The light emitting diode may include, for example, an organic light emitting diode (OLED), a mini light emitting diode (mini-LED) or a micro light emitting diode (micro-LED), a quantum dot light emitting diode (e.g., QLED or QDLED), or any other suitable material or any combination of materials mentioned above, but it is not limited thereto. The antenna device may be, for example, a liquid crystal antenna, a varactor diode antenna or other kinds of antennas, but it is not limited thereto. The tiled device may include, for example, a tiled display device or a tiled antenna device, but it is not limited thereto. Furthermore, the appearance of the electronic devices may be, for example, a rectangular, circular or polygonal shape, a shape with a curved edge, a curved shape or any other suitable shape. An electronic device may have peripheral systems such as a drive system, a control system, a light source system, a shelf system, etc. The electronic device may include an electronic unit, in which the electronic unit may include passive elements and active elements, such as capacitors, resistors, inductors, diodes, transistors, sensors, and the like. It should be noted that the electronic device in this disclosure may be any combination of the above-mentioned devices, but it is not limited to this. The manufacturing method of the electronic device in this disclosure may be applied to, for example, a wafer-level package (WLP) process or a panel-level package (PLP) process, which includes, but is not limited to, a chip-first process or a chip-last process. The electronic device may include, but be not limited to, a system on a chip (SoC), a system in a package (SiP), an antenna in package (AiP) or any combination of the above devices.

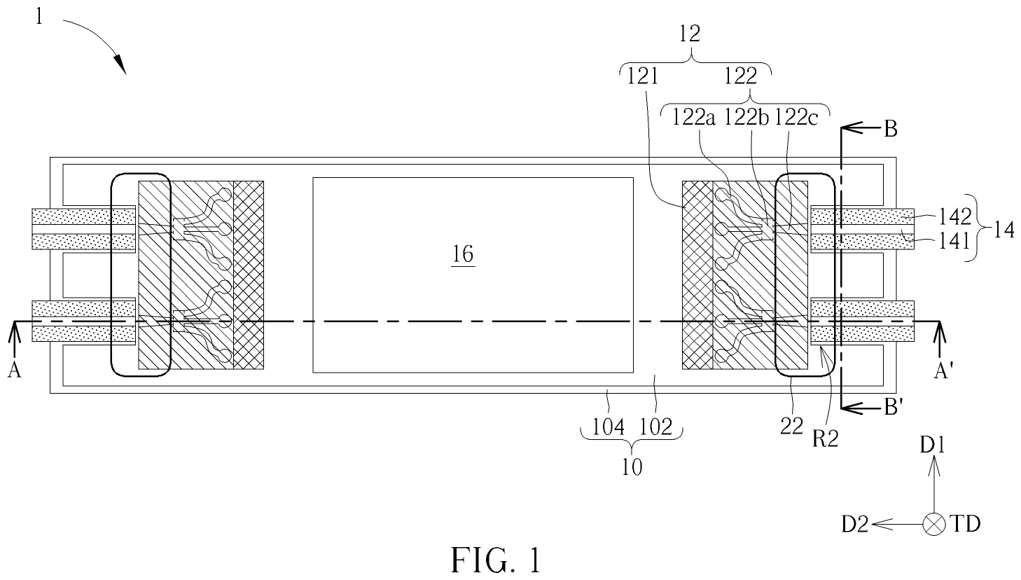

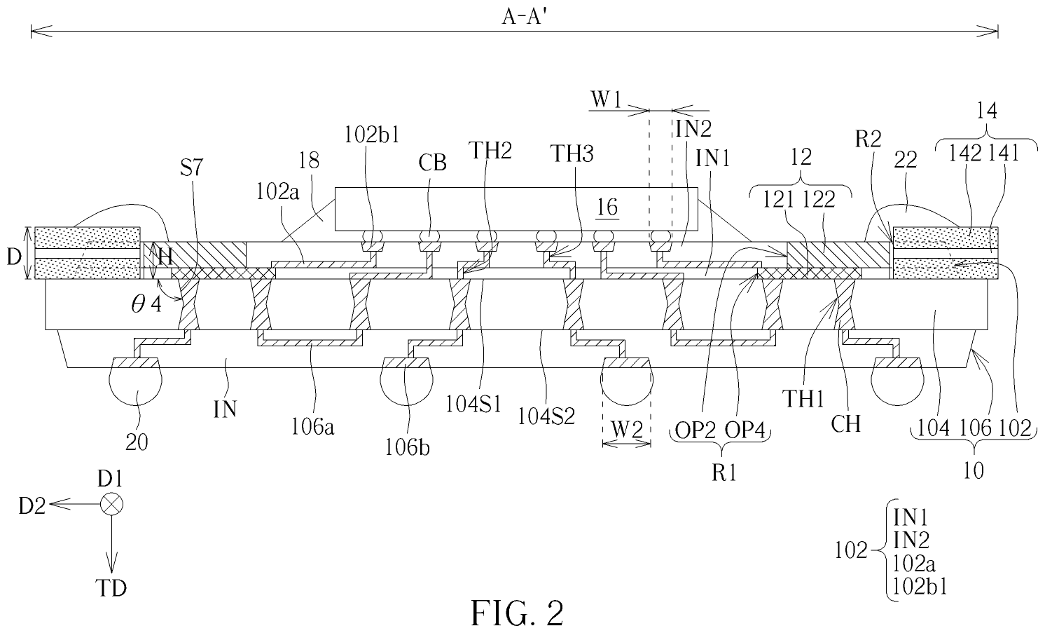

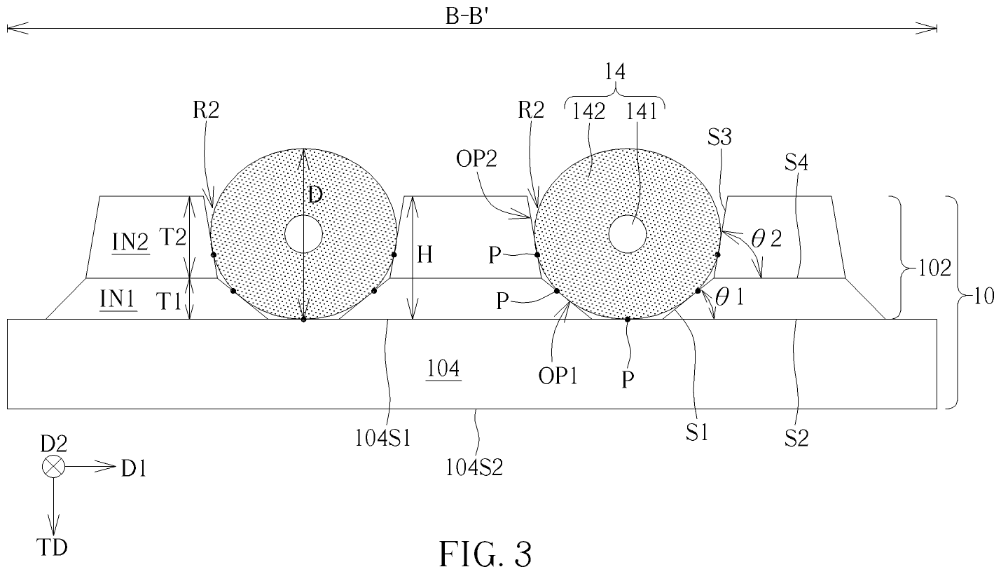

Refer to FIG. 1 to FIG. 3. FIG. 1 schematically illustrates a top view of a semiconductor device according to a first embodiment of the present disclosure. FIG. 2 schematically illustrates a cross-sectional view taken along a section line A-A′ of FIG. 1. FIG. 3 schematically illustrates a cross-sectional view taken along a section line B-B′ of FIG. 1. As shown in FIG. 1 to FIG. 3, the semiconductor device 1 includes a substrate structure 10, at least one photonic unit 12, at least one optical fiber 14 and at least one chip unit 16. The substrate structure 10 includes a coupling member 102, and the photonic unit 12 is disposed in a first recess R1 of the coupling member 102. Furthermore, the photonic unit 12 may be bonded to the coupling member 102 through at least one bonding pad. In other words, the photonic unit 12 may be electrically connected to the coupling member 102 through the bonding pad, which may include a solder ball, conductive glue or any other suitable material. The optical fiber 14 is disposed in a second recess R2 of the coupling member 102 and optically coupled to the photonic unit 12. Meanwhile, the chip unit 16 is disposed on the substrate structure 10 and electrically connected to the photonic unit 12 through the coupling member 102. Furthermore, the depth H of the second recess R2 is greater than or equal to half of the diameter D of the optical fiber 14, so that the part of the optical fiber 14 disposed in the second recess R2 may be easily confined in the second recess R2 without being easily moved out of the second recess R2. As such, it facilitates alignment of the light outlet or light inlet of the optical fiber 14 with the photonic unit 12, thereby reducing optical loss between the photonic unit 12 and the optical fiber 14. The photonic unit 12 is further electrically connected to the chip unit 16 through the coupling member 102 so as to reduce the transmission distance of electrical signals between the photonic unit 12 and the chip unit 16. Accordingly, the chip unit 16 may quickly process the electrical signals generated by the photonic unit 12 or control light signals transmitted by the photonic unit 12, so that the power consumption of the semiconductor device 1 may be reduced and/or the operation efficiency of the semiconductor device 1 may be improved. In this disclosure, the term “coupled” means that one element transmits information to another element. The photonic unit 12 may include, for example, a silicon photonic chip.

In detail, the substrate structure 10 may further include a substrate 104, and the coupling member 102 is disposed on an upper surface 104S1 of the substrate 104. The substrate 104 may include a supporting material for supporting the coupling member 102, the photonic unit 12, the optical fiber 14 and the chip unit 16. The substrate 104 may include a rigid or flexible substrate. The substrate 104 may, for example, be a transparent substrate and have a flat lower surface 104S2 opposite to the flat upper surface 104S1. For example, the substrate 104 may include glass or any other suitable base material. The substrate 104 may, for example, be a glass substrate, a Bismaleimide Triazine (BT) substrate, a glass fiber substrate or any other suitable substrate. According to some embodiments, the photonic unit 12 may be disposed in the coupling member 102 of the substrate structure 10. According to some embodiments, the photonic unit 12 may be disposed on the upper surface 104S1 of the substrate 104. In detail, the coupling member 102 may be processed with a patterning process to form a recess or an accommodation space for the photonic unit 12 to be disposed therein, wherein the patterning process includes, but is not limited to, a thin film process, a photolithography process, a development and etching process, a laser process or any other suitable process.

The substrate structure 10 may further include at least one conductive element CH, which is electrically connected to the coupling member 102 disposed on the upper surface 104S1 of the substrate 104 and another element, e.g., a coupling member 106 to be described later, disposed on the lower surface 104S2 of the substrate 104. The number of the conductive element CH is at least one in the embodiment as illustrated in FIG. 1, but it is not limited thereto. In this disclosure, the conductive element CH may, for example, include a conductive material disposed in a through hole TH1 penetrating through the substrate 104. The conductive material of the conductive element CH may, for example, be a metal material and include titanium, copper, silver, gold, tungsten, cobalt, aluminum, tantalum, an alloy of two or more of the aforementioned elements or any other suitable material. The conductive element CH may be a single-layer structure or a multi-layer structure. As shown in FIG. 1, the conductive element CH may fill the entire through hole TH1 of the substrate 104, but it is not limited thereto. In some embodiments, the conductive element CH may be formed on a sidewall S7 of the through hole TH1 of the substrate 104. In some embodiments, in a cross-sectional view of the semiconductor device 1, a cross-sectional shape of the conductive element CH may be, for example, an hourglass, a rectangle, a trapezoid, an inverted trapezoid or any other suitable shape. In some embodiments, when the substrate 104 is a glass substrate, the through hole TH1 penetrating through the substrate 104 may be called as, for example, a through glass via (TGV), but it is not limited thereto. According to some embodiments, an angle θ4 between the sidewall S7 of the through hole TH1 and one of the surfaces of the substrate 104 (e.g., the upper surface 104S1) may be greater than or equal to 95 degrees (°) and less than or equal to 150°. That is, 95°≤angle θ4≤150°. Alternatively, the angle θ4 is greater than or equal to 105° and less than or equal to 135°. That is, 105°≤angle θ4≤135°. According to some embodiments, the roughness of the sidewall S7 of the through hole TH1 may differ from the roughness of the upper surface 104S1 of the substrate 104; meanwhile, the roughness of the sidewall S7 of the through hole TH1 may be different from the roughness of the lower surface 104S2 of the substrate 104. For example, the roughness of the sidewall S7 of the through hole TH1 is greater than the roughness of the upper surface 104S1 of the substrate 104; meanwhile, the roughness of the sidewall S7 of the through hole TH1 is greater than the roughness of the lower surface 104S2 of the substrate 104. Through the above-described design, the conductive element CH may fill the entire through hole TH1 of the substrate 104, thereby reducing cracking and further improving reliability, but it is not limited thereto.

As shown in FIG. 2, the coupling member 102 may be, for example, a redistribution layer and may include at least one insulating layer and at least one metal layer stacked on each other. In the embodiment as illustrated in FIG. 2, the coupling member 102 may include a plurality of insulating layers and a plurality of metal layers, which are alternately and sequentially stacked on the substrate 104, but it is not limited thereto. The insulating layers of the coupling member 102 may, for example, include an insulating layer IN1 and an insulating layer IN2, which are disposed on the substrate 104. In detail, the insulating layer IN1 is disposed on the substrate 104, and the insulating layer IN2 is disposed on the insulating layer IN1. In some embodiments, the number of the insulating layers may be more than three, but it is not limited thereto. Moreover, the thickness of the insulating layer IN1 and the thickness of the insulating layer IN2 are not limited to those shown in FIG. 2, and instead, they may be adjusted according to requirements. According to some embodiments, description that one element is disposed on another element is just for indicating related positions of the elements rather than limiting the steps of forming the elements.

In addition, the metal layers of the coupling member 102 may form a plurality of wires 102a and a plurality of bonding pads 102b1. To simplify the illustration, not every metal layer is shown in FIG. 2, and instead, wires 102a and bonding pads 102b1 are illustrated as examples of the metal layers. The wires 102a and bonding pads 102b1 may be formed of a single metal layer or multiple metal layers depending on requirements and are not limited to those shown in FIG. 2.

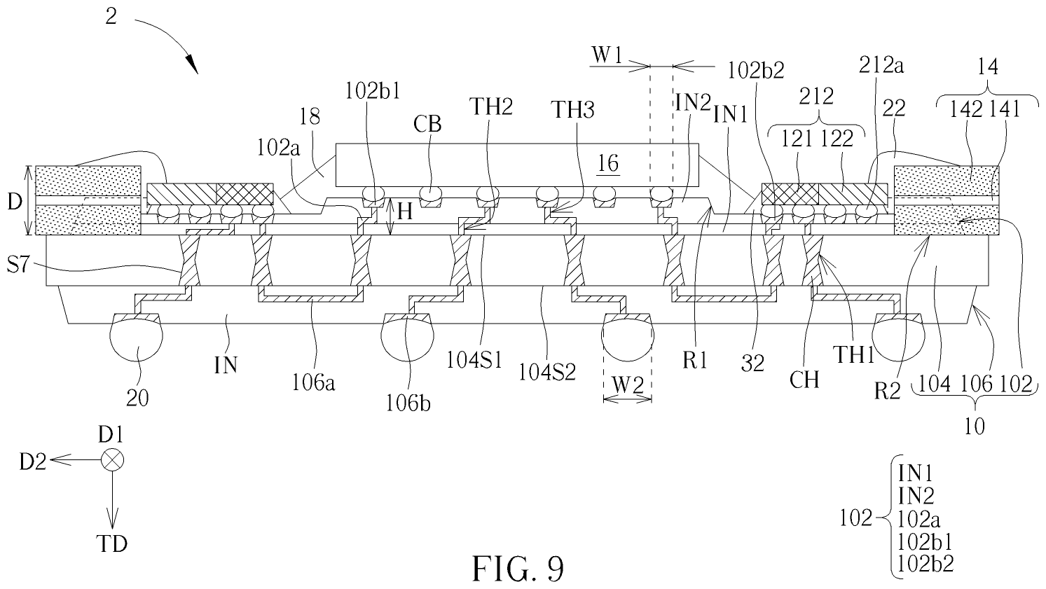

As shown in FIG. 2, the bonding pads 102b1 may be formed of the topmost metal layer of the coupling member 102 and formed in a recess of the topmost insulating layer, e.g., the insulating layer IN2. The bonding pads 102b1 may be electrically connected and bonded to the chip unit 16. Upper surfaces of the bonding pads 102b1 may, for example, be substantially coplanar with an upper surface of the topmost insulating layer, but it is not limited thereto. In some embodiments, the upper surfaces of the bonding pads 102b1 are not coplanar with the upper surface of the topmost insulating layer. For example, the upper surfaces of the bonding pads 102b1 protrude out of the recess of the topmost insulating layer. Alternatively, the upper surfaces of the bonding pads 102b1 may be processed with surface treatment so as to be recessed surfaces, as shown in FIG. 9. The recessed surfaces are thus disposed in the recesses of the topmost insulating layer respectively. The surface treatment, for example, may include but not be limited to, a dry etching, alkaline etching, laser etching or any other suitable process.

In the embodiment as illustrated in FIG. 2, the wires 102a may be formed of a metal layer disposed between the insulating layer IN1 and the insulating layer IN2, a metal layer disposed in a through hole TH2 of the insulating layer IN1 and in a through hole TH3 of the insulating layer IN2, and a metal layer disposed between the insulating layer IN1 and the substrate 104, but it is not limited thereto. The wires 102a are connected to corresponding bonding pads 102b1, respectively, and electrically connect the bonding pads 102b1 to the corresponding conductive elements CH and the corresponding photonic unit 12. At least one of the wires 102a may be used for electrically connecting the photonic unit 12 to at least one of the bonding pads 102b1, and at least another one of the wires 102a may be used for electrically connecting at least another one of the bonding pads 102b1 to the corresponding conductive element CH. The electrical connection configuration of the wires 102a is not limited to the above-described content and may be adjusted according to requirements.

As shown in FIG. 3, the insulating layer IN1 of the coupling member 102 may have at least one opening OP1 penetrating through the insulating layer IN1, and the insulating layer IN2 of the coupling member 102 may have at least one opening OP2 penetrating through the insulating layer IN2. The opening OP1 and the opening OP2 may overlap each other in a top view direction TD of the semiconductor device 1. As such, the opening OP1 and the opening OP2 may form the second recess R2 of the coupling member 102, but it is not limited thereto. In the embodiment as illustrated in FIG. 3, the second recess R2 is a through hole penetrating through the insulating layers of the coupling member 102, e.g., the insulating layer IN1 and the insulating layer IN2. The second recess R2, on the other hand, does not penetrate the metal layers, but it is not limited thereto. The top view direction TD of the semiconductor device 1, for example, may be parallel to the stacking direction of the insulating layers and metal layers of the coupling member 102. In some embodiments, the second recess R2 may be a recess that does not penetrate through the insulating layer IN1. Alternatively, there may be another insulating layer disposed between the opening OP1 of the insulating layer IN1 and the substrate 104, such that the second recess R2 may be a recess formed of the opening OP2, the opening OP1 and the another insulating layer, but it is not limited thereto. In this embodiment, the number of the opening OP2 and the number of the opening OP1 may be both plural so as to form a plurality of second recesses R2. In this case, the semiconductor device 1 may include a plurality of optical fibers 14, and each of the second recesses R2 may be used for accommodating a corresponding one of the optical fibers 14, but not limited thereto.

In the embodiment as illustrated in FIG. 3, the thickness T1 of the insulating layer IN1 may be less than the thickness T2 of the insulating layer IN2, so as to facilitate accommodation of the optical fiber 14 into the formed second recess R2. For example, the insulating layer IN1 may have two sidewalls S1 facing the second recess R2 and a lower surface S2 facing the substrate 104; the insulating layer IN2 may have two sidewalls S3 facing the second recess R2 and a lower surface S4 facing the insulating layer IN1; and an angle θ1 between one of the sidewalls S1 and the lower surface S2 have may be less than an angle θ2 between one of the sidewalls S3 and the lower surface S4. For example, the angle θ1 may be greater than 0° and less than or equal to 50° (0°≤angle θ1≤50°), and the angle θ2 may be greater than 50° and less than or equal to 95° (50°≤angle θ2≤95°).

Furthermore, the minimum width of the opening OP1 of the insulating layer IN1 in a first direction D1 parallel to the lower surface S2 may be less than the minimum width of the opening OP2 of the insulating layer IN2 in the first direction D1. The first direction D1 may be, for example, perpendicular to the extending direction of the optical fiber 14 (e.g., a second direction D2). Since a cross-sectional view of the optical fiber 14 may be, for example, circular or nearly circular in the cross-sectional view of the semiconductor device 1 along the first direction D1, the number of contact points P of the optical fiber 14 with the substrate structure 10 may be greater than three in this design, which is helpful in fixing or confining the optical fiber 14 in the second recess R2, or in unifying the fixed positions of different optical fibers 14 respectively in the second recesses R2. For example, the optical fiber 14 disposed in the second recess R2 may be in contact with the two sidewalls S3 of the insulating layer IN2, the two sidewalls S1 of the insulating layer IN1 and the upper surface 104S1 of the substrate 104, so that the number of the contact points P may be five, but it is not limited thereto. In some embodiments, the optical fiber 14 may be not in contact with one of the sidewalls S1, one of the sidewalls S3 or the upper surface 104S1 of the substrate 104, but not limited thereto.

As shown in FIG. 2, the substrate structure 10 may further include another coupling member 106, which is disposed on the lower surface 104S2 of the substrate 104 away from the upper surface 104S1, and the coupling member 106 may be used for electrical connection with an external device (e.g., a circuit board). Furthermore, the coupling member 102 may be electrically connected to the coupling member 106 through the conductive element CH. Therefore, the chip unit 16 and the photonic unit 12 may be electrically connected to the external device through the coupling member 102, the conductive element CH and the coupling member 106.

The coupling member 106 may be similar to the coupling member 102 and may be, for example, a redistribution layer. Therefore, the coupling member 106 may include at least one insulating layer and at least one metal layer, and the at least one metal layer and the at least one insulating layer may be alternately stacked on the lower surface 104S2 of the substrate 104. In FIG. 3, the coupling member 106 is omitted in order to clearly show the relationships between the optical fiber 14 and the insulating layer IN1 between the optical fiber 14 and the insulating layer IN2, but it is not limited to this.

In FIG. 2, the insulating layer of the coupling member 106 is illustrated as a single insulating layer IN, but the number of the insulating layer is not limited. The metal layer of the coupling member 106 is illustrated as wires 106a and bonding pads 106b, and the number of the metal layer is not limited. The bonding pads 106b may be formed of the bottommost metal layer of the coupling member 106 and formed in recesses of the bottommost insulating layer respectively. The bonding pads 106b may be electrically connected and bonded to an external device. Lower surfaces of the bonding pads 106b may, for example, be substantially coplanar with a lower surface of the bottommost insulating layer of the coupling member 106, but it is not limited thereto. In some embodiments, the lower surfaces of the bonding pads 106b are not coplanar with the lower surface of the bottommost insulating layer. For example, the lower surfaces of the bonding pads 106b away from the lower surface 104S2 of the substrate 104 may be processed with surface treatment so as to be recessed surfaces, as shown in FIG. 9. The recessed surfaces are thus respectively disposed in the recesses of the bottommost insulating layer or protruding out of the recesses of the bottommost insulating layer. Referring to FIG. 9, according to some embodiments, the width W1 of the bonding pad 102b1 may be less than the width W2 of the bonding pad 106b, wherein the width W1 may be ranged from 15 μm to 45 μm, and the width W2 may be ranged from 150 μm to 350 μm.

As shown in FIG. 2, the wires 106a may be electrically connected to the corresponding conductive elements CH, respectively. In an embodiment, at least one of the wires 106a may be connected to a corresponding bonding pad 106b, or at least one of the wires 106a may be electrically connected to two conductive elements CH, but it is not limited thereto. The electrical connection configuration of the wires 106a may be adjusted according to requirements.

The insulating layer IN1, the insulating layer IN2 and the insulating layer IN may include, for example, organic material or inorganic material, wherein the thickness of one of these insulating layers may be ranged from 0.1 μm to 50 μm. The organic material may include, for example, photosensitive polyimide (PSPI), polyimide (PI), build-up material (ABF), resin, epoxy or any other suitable material. The inorganic material may include, for example, silicon oxide, silicon nitride or any other suitable material. In the embodiment as illustrated in FIG. 3, the sidewalls S1 and the sidewalls S3 may be straight lines in the cross-sectional view of the semiconductor device 1, but it is not limited thereto. In some embodiments, the sidewalls S1 and the sidewalls S3 may be curved. In this case, a part of the surface of the optical fiber 14 may conform to a part of at least one of the sidewalls S1 and/or a part of at least one of the sidewalls S3, but it is not limited thereto. The wires 102a, the bonding pads 102b1, the wires 106a and the bonding pads 106b may include conductive materials, or the wires 102a, the bonding pads 102b1, the wires 106a and the bonding pads 106b may include metal materials, such as copper or any other suitable material. Each wire 102a, bonding pad 102b1, wire 106a and bonding pad 106b may include a single layer of material or a multilayer stack of material, wherein the thickness of one of wires may be ranged from 2 μm to 15 μm, and the thickness of one of the bonding pads may be ranged from 5 μm to 251 μm. According to some embodiments, the sidewall S1 and the sidewall S3 may be rough. In other words, the roughness of the sidewall S1 and the roughness of the sidewall S3 are greater than the roughness of the surface of the optical fiber 14, so that the optical fiber 14 may be disposed in the second recess R2.

As shown in FIG. 1 and FIG. 2, the optical fiber 14 may be strip-shaped and extend along the second direction D2. The optical fiber 14 may include a core portion 141 and a cladding portion 142, and the cladding portion 142 may surround the core portion 141. For example, the refractive index of the cladding portion 142 may be less than that of the core portion 141, so that light signal may propagate in the core portion 141. In the embodiment as illustrated in FIG. 1, the optical fiber 14 may, for example, include a single-mode optical fiber or a multi-mode optical fiber. The core portion 141 may include, for example, a single fiber core or a plurality of fiber cores. It should be noted that since the depth H of the second recess R2 may be greater than or equal to half the diameter D of the optical fiber 14, the optical fiber 14 is not easily displaced out of the second recess R2. Accordingly, optical loss between the photonic unit 12 and the optical fiber 14 may be reduced. The diameter D of the optical fiber 14 may be, for example, greater than or equal to 100 μm.

In the embodiment as illustrated in FIG. 2, the first recess R1 of the coupling member 102 may be a through hole penetrating through the coupling member 102, and the first recess R1 may be connected to the second recess R2, but it is not limited thereto. In detail, the insulating layer IN1 may have at least one opening OP4, and the opening OP4 may overlap the opening OP2 of the insulating layer IN2 in the top view direction TD. In this case, the opening OP4 and a part of the opening OP2 may form the first recess R1, but not limited thereto. Since a part of the first recess R1 and a part of the second recess R2 may be formed of the same opening OP2, the first recess R1 may be connected to the second recess R2, but it is not limited thereto.

The photonic unit 12 may include a photoelectric element 121 and a waveguide element 122, wherein the optical fiber 14 may be optically coupled to the waveguide element 122, so that the waveguide element 122 may be used for guiding the light signal of the optical fiber 14 to the photoelectric element 121 or guiding the light signal of the photoelectric element 121 to the optical fiber 14. The photoelectric element 121 may include a light emitting element that converts the electrical signal into the light signal or include a light receiving element that converts the light signal into the electrical signal. For example, the photoelectric element 121 may include a photo-detector, a photodiode, a PIN diode, a photoresistor, a vertical-cavity surface-emitting laser (VCSEL), a photonic-crystal surface-emitting laser (PCSEL), an edge-emitting laser (EEL) or any other suitable element.

In the embodiment as illustrated in FIG. 2, the photoelectric element 121 may be disposed in the opening OP4 of the insulating layer IN1, and the waveguide element 122 may be disposed in the opening OP2 of the insulating layer IN2, but it is not limited thereto. By the overlap between the opening OP4 and the opening OP2, the photoelectric element 121 may directly contact the waveguide element 122. Furthermore, since a part of the first recess R1 and a part of the second recess R2 are formed of the same opening OP2, the waveguide element 122 is helped to be aligned with the optical fiber 14. In detail, the photoelectric element 121 may be directly formed on the upper surface 104S1 of the substrate 104, so that a part of the photoelectric element 121 may be disposed between the insulating layer of the coupling member 102 and the substrate 104, but it is not limited thereto. The waveguide element 122 may be disposed on the photoelectric element 121, and in the second direction D2, the waveguide element 122 may be aligned with the core portion 141 of the optical fiber 14, but it is not limited thereto. In some embodiments, the photoelectric element 121 may be disposed on the waveguide element 122, but it is not limited thereto.

In the embodiment as illustrated in FIG. 1, the waveguide element 122 may include a waveguide path 122a, a beam splitter 122b, and a taper waveguide 122c. The taper waveguide 122c may be aligned with the core portion 141 of the optical fiber 14 in the second direction D2. The width of the taper waveguide 122c at one end near the optical fiber 14 may be close to or slightly greater than the diameter of the core portion 141 of the optical fiber 14 in order to reduce optical loss of light emitted from the optical fiber 14 into the waveguide element 122. On the other hand, the width of the taper waveguide 122c at the other end away from the optical fiber 14 may be less than the diameter of the core portion 141 in order to miniaturize the waveguide element 122, but it is not limited thereto. The beam splitter 122b may be disposed at the other end of the taper waveguide 122c away from the optical fiber 14 and connected between the taper waveguide 122c and the waveguide path 122a. The beam splitter 122b may be connected to at least one waveguide path 122a. The waveguide path 122a may be optically coupled with the photoelectric element 121, so that light from the waveguide path 122a may be received by the photoelectric element 121, or light generated by the photoelectric element 121 may be emitted into the waveguide path 122a. In some embodiments, one photoelectric element 121 may, but be not limited to, correspond to one or more waveguide paths 122a, and may be adjusted according to requirements. In some embodiments, the waveguide element 122 may optionally exclude the beam splitter 122b and the taper waveguide 122c.

In the embodiment as illustrated in FIG. 1, the light receiving element is taken as an example of the photoelectric element 121. The beam splitter 122a may be connected to a plurality of waveguide paths 122a to divide the light signal from the taper waveguide 122c into a plurality of light signals and distribute them to different waveguide paths 122a. Through the waveguide paths 122a, the light signals may be transmitted to the same photoelectric element 121 or different photoelectric elements 121 for subsequent signal processing. On the contrary, when the photoelectric element 121 is a light emitting element, light signals in a plurality of waveguide paths 122a may be converged to the taper waveguide 122c through the beam splitter 122b, and then transmitted to the optical fiber 14. It is thus understood that the light may be transmitted from the optical fiber 14 to the photoelectric element 121 through the waveguide element 122. The waveguide element 122 may be, for example, a planar optical waveguide element or any other suitable element. For example, the waveguide element 122 may further include a base layer and a cover layer (not shown), wherein the waveguide path 122a, the beam splitter 122b and the taper waveguide 122c are disposed between the base layer and the cover layer. As such, the waveguide path 122a, the beam splitter 122b and the taper waveguide 122c may be clad with the base layer and the cover layer. Furthermore, since the refractive index of the base layer and the refractive index of the cover layer both are less than the refractive index of the waveguide path 122a, the refractive index of the refractive index of the beam splitter 122b, and the refractive index of the refractive index of the taper waveguide 122c, light may be transmitted through the waveguide path 122a, the beam splitter 122b and the taper waveguide 122c. In some embodiments, the waveguide path 122a, the beam splitter 122b and the taper waveguide 122c may include the same light guiding material, but it is not limited thereto. The waveguide element 122 may include, for example, silicon oxide, silicon nitride or any other suitable material.

In some embodiments, when the semiconductor device 1 includes a plurality of photonic units 12, different photonic units 12 may respectively include the light emitting element that converts the electrical signal into the light signal and the light receiving element that converts the light signal into the electrical signal, so that the semiconductor device 1 may have functions of generating and receiving light signals, but it is not limited thereto.

As shown in FIG. 2, the chip unit 16 may be disposed on the coupling member 102. For example, the chip unit 16 may be bonded and electrically connected to the bonding pads 102b1 of the coupling member 102 through a plurality of bonding pads CB. In detail, the bonding pads CB may contact corresponding input/output (I/O) ends of the chip unit 16 and the corresponding bonding pads 102b1 of the coupling member 102 respectively, thereby achieving the electrical connection between the chip unit 16 and the coupling member 102. The chip unit 16 may be electrically connected to the photoelectric element 121 through the wires 102a of the coupling member 102 to control or turn on/off the photoelectric element 121, or to process the electric signal converted by the photoelectric element 121. For example, the chip unit 16 may include a switch chip, a control chip, a signal processing chip, a computing chip or any other suitable semiconductor chip.

In some embodiments, the semiconductor device 1 may further include an underfill layer 18, which is disposed between the coupling member 102 and the chip unit 16 and is used for improving the adhesion between the chip unit 16 and the coupling member 102.

In some embodiments, the semiconductor device 1 may further include a plurality of conductive terminals 20, which are respectively disposed on the bonding pads 106b for being bonded to external components. The conductive terminals 20 may include, for example, solder balls, conductive bumps, or other suitable elements. The materials of the bonding pads CB and the conductive terminals 20 may include, but are not limited to, tin, nickel, copper, silver, gold, gallium, indium, tantalum, aluminum, combinations of the above or other suitable materials.

In some embodiments, the semiconductor device 1 may include an adhesive 22 disposed on a part of the optical fiber 14 disposed in the second recess R2 for fixing the optical fiber 14 in the second recess R2, thereby reducing or avoiding optical loss caused by the displacement of the optical fiber 14. The adhesive 22 may include transparent adhesive or opaque adhesive. The adhesive 22 may include, for example, UV adhesive, optical adhesive, double-sided tape adhesive or any other suitable adhesive.

It should be noted that in the semiconductor device 1 of this embodiment, the photonic unit 12 may be formed in the coupling member 102, and the position of the optical fiber 14 may be restricted by the second recess R2 of the coupling member 102. In addition, the chip unit 16 may further be electrically connected to the photonic unit 12 through the coupling member 102. Therefore, a photonic system may be formed without any additional circuit board, thereby reducing the size of the whole photonic system.

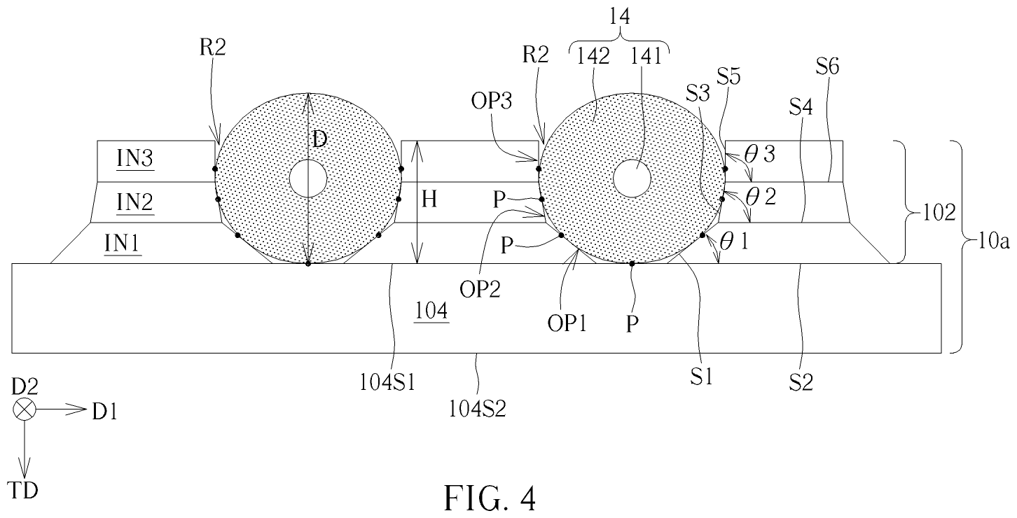

Refer to FIG. 4, which is a cross-sectional view of a substrate structure and optical fibers according to a variant embodiment of the first embodiment of the present disclosure. In order to clearly show the relationship between the optical fibers 14 and insulating layers of the coupling member 102, the coupling member 106 is omitted in FIG. 4, but it is not limited thereto. As shown in FIG. 4, substrate structure 10a of this variant embodiment differs from the substrate structure 10 described above in that the coupling member 102 may include three or more insulating layers. For example, the coupling member 102 may further include an insulating layer IN3, wherein the insulating layer IN1 is disposed on the substrate 104, the insulating layer IN2 is disposed on the insulating layer IN1, and the insulating layer IN3 is disposed on the insulating layer IN2. The insulating layer IN3 may have at least one opening OP3, which penetrates through the insulating layer IN3. The second recess R2 may penetrate through the insulating layer IN1, the insulating layer IN2 and the insulating layer IN3 and be formed of the opening OP3, the opening OP2 and the opening OP1, but it is not limited thereto. In some embodiments, the second recess R2 may be a recess that does not penetrate the insulating layer IN1, but is formed of the opening OP3, the opening OP2 and the recess or the upper surface of the insulating layer IN1, but it is not limited thereto. The material of the insulating layer IN3 may be the same as or similar to that of the insulating layer IN1 and/or the insulating layer IN2, for example, so its reference may be made to the above content and its details are not repeatedly described herein. In this embodiment, the first recess R1 for accommodating the photonic unit may be formed of insulating layers of the coupling member 102, e.g., the insulating layer IN1, the insulating layer N2 and the insulating layer IN3, but it is not limited thereto.

In detail, the insulating layer IN3 may have two sidewalls S5 facing the second recess R2 and a lower surface S6 facing the insulating layer IN2, and an angle θ3 between one of the sidewalls S5 and the lower surface S6 may be greater than the angle θ2 between one of the sidewalls S3 and the lower surface S4. Consequently, the angle θ1, the angle θ2 and the angle θ3 may increase in order. In an embodiment, the minimum width of the opening OP1 of the insulating layer IN1 in the first direction D1, the minimum width of the opening OP2 of the insulating layer IN2 in the first direction D1, and the minimum width of the opening OP3 of the insulating layer IN3 in the first direction D1 may increase in order, so that the optical fiber 14 may be stably disposed in the second recess R2, but it is not limited thereto. For example, the optical fiber 14 may be in contact with the two sidewalls S5 of the opening OP3, the two sidewalls S3 of the opening OP2, the two sidewalls S1 of the opening OP1 and the upper surface 104S1 of the substrate 104. In this case, the number of contact points P may be, but not limited to, seven. In some embodiments, the thickness of the insulating layer IN1, the thickness of the insulating layer IN2, and the thickness of the insulating layer IN3 may decrease in order, but it is not limited thereto. The thicknesses of the insulating layer IN1, the insulating layer IN2 and the insulating layer IN3 are not limited to those shown in FIG. 4, but may be adjusted as required. Since other parts of the semiconductor device in this variant embodiment may be the same as or similar to those described in the above embodiment, they will not be described in detail herein.

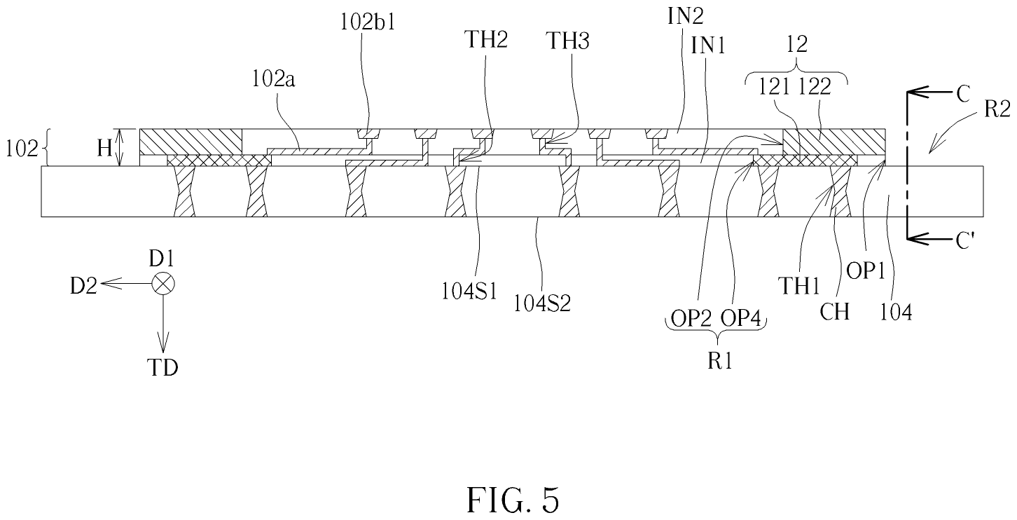

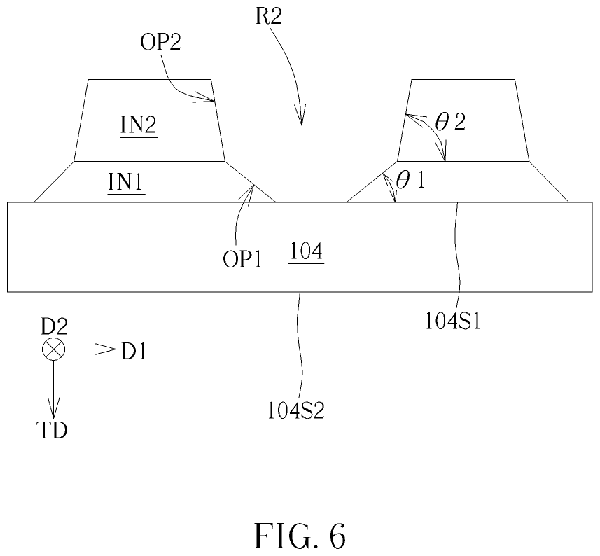

The manufacturing method of the semiconductor device 1 in this embodiment will be further explained below. Refer to FIG. 5 to FIG. 8, which are schematic diagrams illustrating cross-sectional views of structures in different steps of manufacturing the semiconductor device according to the first embodiment of the present disclosure, respectively, wherein FIG. 6 is a schematic cross-sectional view taken along a section line C-C′ of FIG. 5. The manufacturing method of the semiconductor device 1 may include forming the substrate structure 10 and the photonic unit 12, disposing the chip unit 16 on the substrate structure 10, and disposing the optical fiber 14 in the second recess R2 of the substrate structure 10. In this embodiment, the step of fabricating the photonic unit 12 may be integrated into the step of forming the substrate structure 10, but it is not limited thereto. The manufacturing method of the semiconductor device in this embodiment will be described in detail with reference to FIG. 5 to FIG. 8 and FIG. 2, but it is not limited thereto.

As shown in FIG. 5, the step of forming the substrate structure 10 includes providing the substrate 104 and forming the coupling member 102 on the upper surface 104S1 of the substrate 104. In the step of providing the substrate 104, at least one conductive element CH may be formed in the substrate 104. The step of forming the conductive element CH may include forming the through hole TH1 in the substrate 104 and forming the conductive material in the through hole TH1. The manner of forming the through hole TH1 may include, for example, laser drilling, ultrasonic drilling, micro electrical discharge machining (micro-EDM), micro powder blasting, inductively coupled plasma reactive etching (ICP-RIE), photolithography with etching or any other suitable process. The manner of forming the conductive material may include, for example, an electroplating process, an electroless plating process, a physical vapor deposition, PVD) process, a liquid metal filling process or any other suitable process.

In the step of forming the coupling member 102, the photonic unit 12 may also be formed on the substrate 104. In detail, as shown in FIG. 5, after the conductive element CH is formed, the photoelectric element 121 may be formed or disposed on the upper surface 104S1 of the substrate 104 before the coupling member 102 is formed. The photoelectric element 121 may be formed on the substrate 104 through, for example, the thin film process or any other suitable process. Alternatively, the photoelectric element 121 may be an independent chip or element, which is disposed on the substrate 104 through, for example, a die bonding process.

After the photoelectric element 121 is formed or disposed, the insulating layers (e.g., an insulating layer IN1 and an insulating layer IN2), the wires 102a, the bonding pads 102b1, and the waveguide element 122 may be formed on the upper surface 104S1 of the substrate 104 and the photoelectric element 121, thereby forming the coupling member 102 and the photonic unit 12. In the embodiment as illustrated in FIG. 5, the step of forming the insulating layers may include forming the insulating layer IN1 on the substrate 104 and forming the insulating layer IN2 on the insulating layer IN1. The step of forming the insulating layer IN1 may include forming the opening OP1 and the opening OP4 in the insulating layer IN1. The step of forming the insulating layer IN2 may include forming the opening OP2 in the insulating layer IN2. The method of forming the insulating layer IN1 and the insulating layer IN2 may include, for example, a laminating process, a coating process or any other suitable process. The manner of forming the openings may include, for example, an exposure and development process, a photolithography and etching process or any other suitable process, which may be determined according to types of materials. The step of forming the waveguide element 122 may be integrated into the step of forming the insulating layers or formed after the step of forming the insulating layers. For example, when the material of the waveguide element 122 is different from the materials of the insulating layer IN1 and the insulating layer IN2, the waveguide element 122 may be formed between the step of forming the insulating layer IN1 and the step of forming the insulating layer IN2, or formed in the opening OP2 of the insulating layer IN2 after the step of forming the insulating layer IN2. In some embodiments, the waveguide element 122 may be an independent chip or element and be disposed in the opening OP2 of the coupling member 102 after the coupling member 102 is formed.

It should be noted that, as shown in FIG. 5 and FIG. 6, the opening OP1 of the insulating layer IN1 corresponding to the second recess R2 may be formed in the step of forming the insulating layer IN1, and the opening OP2 of the insulating layer IN2 corresponding to the second recess R2 may be formed in the step of forming the insulating layer IN2. Accordingly, an extra step for forming the second recess R2 is not necessary. For example, the opening OP1 and the through hole TH2 of the insulating layer IN1 may be formed at the same time, in the same step or in different steps, and the opening OP2 and the through hole TH3 of the insulating layer IN2 may be formed at the same time, in the same step or in different steps, but it is not limited thereto.

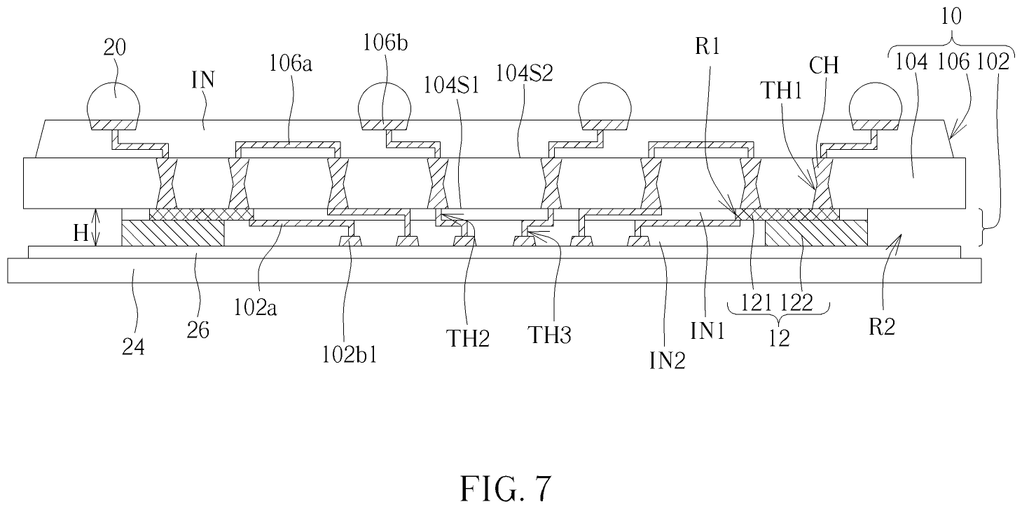

As shown in FIG. 7, after the coupling member 102 and the photonic unit 12 are formed, the substrate 104 with the coupling member 102 and the photonic unit 12 formed thereon is turned upside down and placed on a carrier plate 24 to expose the lower surface 10452 of the substrate 104, wherein a release layer 26 is disposed between the carrier plate 24 and the coupling member 102 to facilitate detachment of the coupling member 102 from the carrier plate 24 in a subsequent step. Subsequently, another coupling member 106 is formed on the lower surface 10452 of the substrate 104, so that the substrate structure 10 may be formed. For example, the step of forming the coupling member 106 may be the same as or similar to the steps of forming the insulating layers (e.g., the insulating layer IN1 and the insulating layer IN2), the wires 102a and the bonding pads 102b1 and not repeatedly described herein. In some embodiments, a plurality of conductive terminals 20 may be optionally formed on the bonding pads 106b of the coupling member 106.

In the embodiment as illustrated in FIG. 7, the distribution density of the wires 106a of the coupling member 106 may be less than that of the wires 102a of the coupling member 102, but it is not limited thereto. Forming the coupling member 102 before the step of forming the coupling member 106 may help to reduce the process complexity, for example, mitigate warpage of the substrate 104. In some embodiments, the step of forming the coupling member 106 may be performed before forming the coupling member 102 and the photonic unit 12.

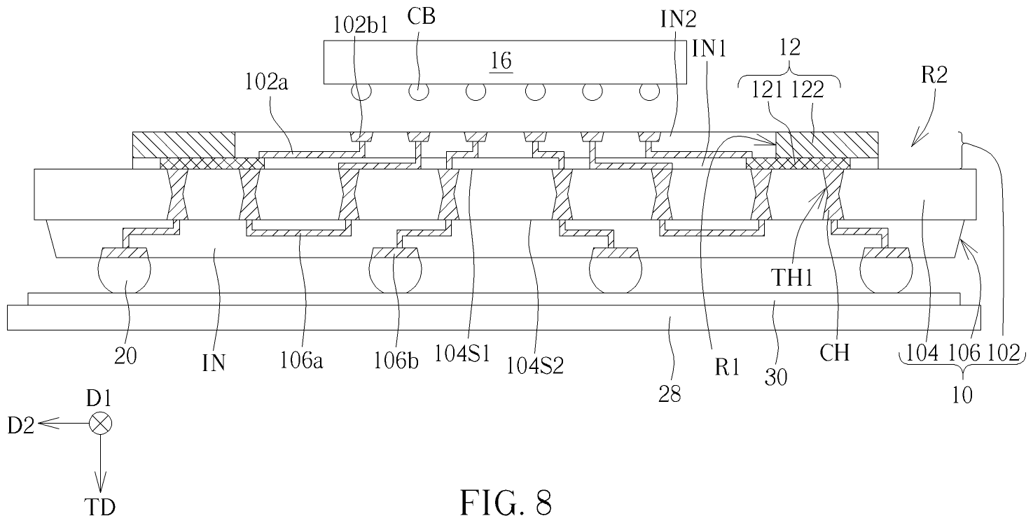

As shown in FIG. 8, after the conductive terminals 20 are formed, the substrate structure 10 may be turned upside down, and the conductive terminals 20 may be placed on another carrier plate 28 to expose the bonding pads 102b1 of the coupling member 102. Another release layer 30 may be disposed between the carrier plate 28 and the conductive terminals 20 to facilitate detachment of the conductive terminals 20 from the carrier plate 28 in a subsequent step. It should be noted that the conductive terminals 20 have certain hardness before heating so as to be supportive. Then, the chip unit 16 is disposed on the bonding pads 102b1 of the substrate structure 10. The chip unit 16 may be bonded and electrically connected to the bonding pads 102b1 by, for example, a flip chip process or any other suitable process.

As shown in FIG. 2, after the chip unit 16 is disposed, the underfill layer 18 may be formed on the coupling member 102 and the sidewalls of the chip unit 16, so that the underfill layer 18 may surround the chip unit 16 in the top view direction TD of the semiconductor device 1, which facilitates adhesion of the chip unit 16 to the coupling member 102. As the underfill layer 18 has good fluidity before curing, the underfill layer 18 may be formed between the coupling member 102 and the chip unit 16, but it is not limited thereto. Subsequently, the optical fiber 14 may be disposed in the second recess R2, and the optical fiber 14 may be fixed in the second recess R2 through the adhesive 22, thereby forming the semiconductor device 1 in this embodiment.

The semiconductor device and its manufacturing method are not limited to the above embodiments, and there may be other embodiments. To simplify the illustration, the same reference numerals as the above-mentioned embodiment will be used in the following embodiments to mark the same elements. In order to easily compare the following embodiments with the above-mentioned embodiment, the differences between the embodiments will be highlighted below, and the repeated parts will not be repeatedly described herein.

Refer to FIG. 9, which is a schematic cross-sectional view of a semiconductor device according to a second embodiment of the present disclosure. As shown in FIG. 9, the semiconductor device 2 provided in this embodiment is different from the semiconductor device mentioned in the above embodiment in that a photonic unit 212 in this embodiment may be an independent chip or element and disposed on the substrate structure 10 after the step of forming the substrate structure 10. For example, the photoelectric element 121 and the waveguide element 122 of the photonic unit 212 may be arranged side by side to constitute a single chip or element, but it is not limited thereto.

In detail, the first recess R1 of the coupling member 102 may not penetrate through the coupling member 102 and be disposed at one side of the second recess R2, and the photonic unit 212 may be disposed in the first recess R1. The coupling member 102 may further include bonding pads 102b2 exposed from the bottom of the second recess R2, and the photonic unit 212 may further include a plurality of bonding pads 212a respectively bonded and electrically connected to the bonding pads 102b2 of the coupling member 102. In the embodiment as illustrated in FIG. 9, the depth of the first recess R1 may be less than the depth of the second recess R2, so that the waveguide element 122 of the photonic unit 212 may be aligned with the core portion 141 of the optical fiber 14, but it is not limited thereto. Since other parts of the semiconductor device 2 in this embodiment may be the same as or similar to those in the above embodiment, they will not be described in detail herein.

In some embodiments, the semiconductor device 2 may further include another underfill layer 32, which is disposed between the coupling member 102 and the photonic unit 212 and used for increasing the adhesion between the photonic unit 212 and the coupling member 102.

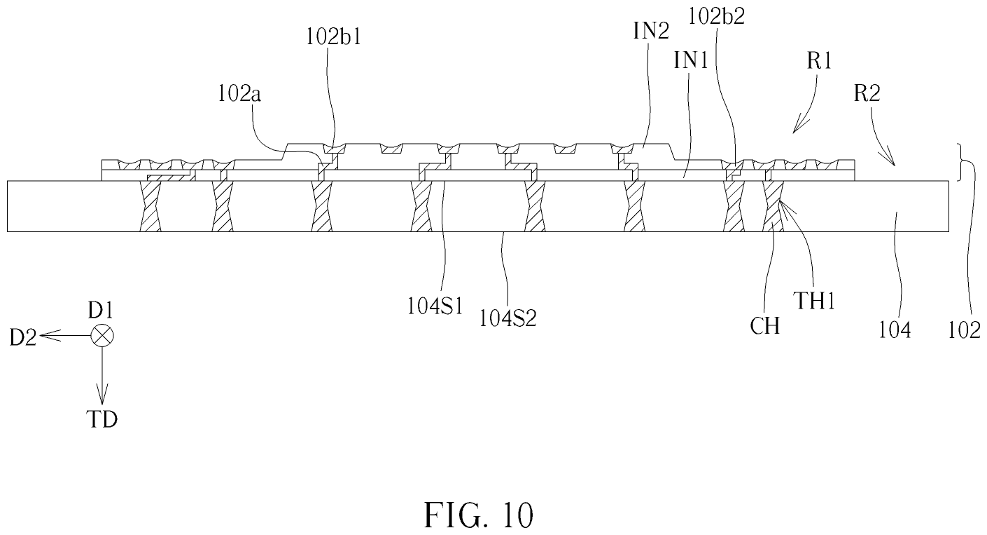

Refer to FIG. 10 to FIG. 12, which are schematic cross-sectional views illustrating structures in different steps of manufacturing the semiconductor device according to the second embodiment of the present disclosure, respectively. The manufacturing method of the semiconductor device 2 in this embodiment will be described in detail with reference to FIG. 10 to FIG. 12 and FIG. 9, but it is not limited thereto. As shown in FIG. 10, the substrate 104 is first provided, and the conductive element CH is formed in the substrate 104. Then, the coupling member 102 is formed on the substrate 104. The step of forming the conductive element CH in this embodiment may be similar to or the same as those mentioned in the above embodiment. Therefore, references may be made to the above, and details are not repeatedly described herein.

The step of forming the coupling member 102 may include, for example, forming the insulating layers (e.g., the insulating layer IN1 and the insulating layer IN2), the wires 102a, the bonding pads 102b1, and the bonding pads 102b2 on the upper surface 104S1 of the substrate 104. In the embodiment as illustrated in FIG. 10, the first recess R1 may be formed in the insulating layer IN2, and for example, be formed of the opening OP2, but it is not limited thereto. In some embodiments, the depth of the first recess R1 may be adjusted as required, and for example, the first recess R1 may extend into the insulating layer IN1, but it is not limited thereto. Since the steps of forming the insulating layers, the wires 102a and the bonding pads 102b1 may be the same as or similar to those mentioned in the above embodiment, their details are not repeated herein. Furthermore, the bonding pads 102b2 may be formed at the bottom of the first recess R1, for example, after the first recess R1 is formed, but it is not limited thereto. Since the step of forming the bonding pads 102b2 may be the same as or similar to the manner of forming the bonding pads 102b1, it will not be repeatedly described herein.

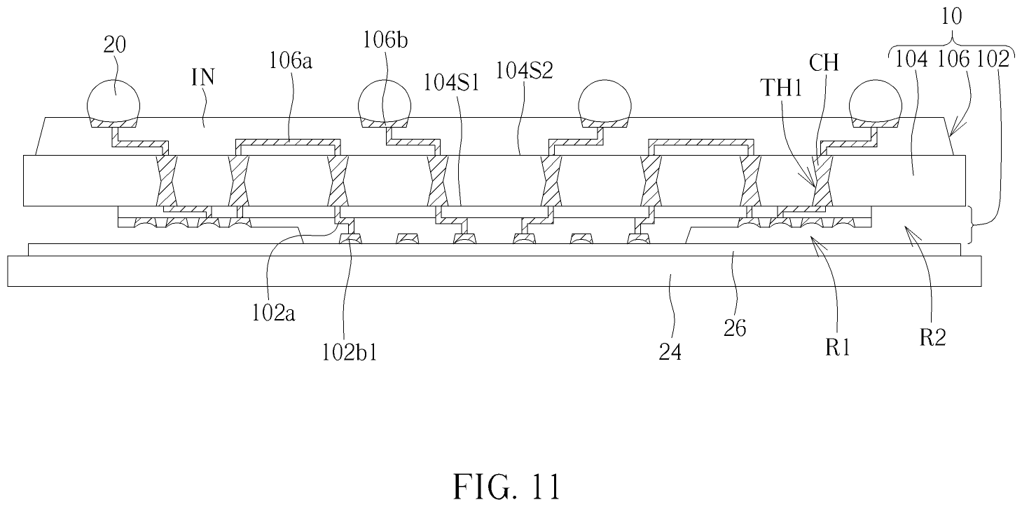

As shown in FIG. 11, after the coupling member 102 is formed, the substrate 104 with the coupling member 102 formed thereon is turned upside down and placed on the carrier plate 24, such that the lower surface 104S2 of the substrate 104 faces upwards. Subsequently, the coupling member 106 is formed on the lower surface 104S2 of the substrate 104, thereby forming the substrate structure 10. Then, a plurality of conductive terminals 20 may be optionally formed on the bonding pads 106b of the coupling member 106. In this embodiment, the steps of forming the coupling member 106 and the conductive terminals 20 may be the same as or similar to those described in the above embodiment, so their references may be made to the above contents, and their details are not repeated herein. In some embodiments, the step of forming the coupling member 106 and the conductive terminals 20 may be formed before forming the coupling member 102, but it is not limited thereto.

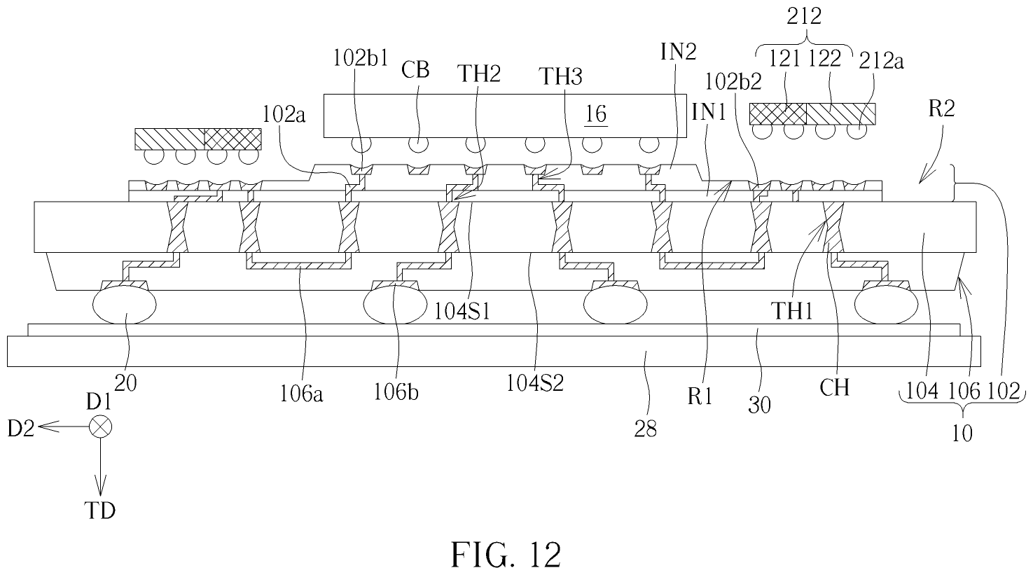

As shown in FIG. 12, after the conductive terminals 20 are formed, the substrate structure 10 is turned upside down and placed on the carrier plate 28 to expose the boding pads 102b1 and the boding pads 102b2 of the coupling member 102. Then, the chip unit 16 is disposed on the bonding pads 102b1 of the coupling member 102, and the photonic unit 212 is disposed on the bonding pads 102b2 in the first recess R1, so that the chip unit 16 and the photonic unit 212 may be electrically connected to the coupling member 102 respectively through the bonding pads 102b1 and the bonding pads 102b2. Since the steps of disposing the chip unit 16 and the photonic unit 212 on the coupling member 102 do not affect each other, the step of disposing the photonic unit 212 on the coupling member 102 may be performed before or after the step of disposing the chip unit 16 on the coupling member 102, or may be performed simultaneously with the step of disposing the chip unit 16.

As shown in FIG. 9, after the chip unit 16 and the photonic unit 212 are disposed, the underfill layer 18 may be formed on the coupling member 102 and the sidewalls of the chip unit 16, and the underfill layer 32 may be formed in the first recess R1 and the sidewalls of the photonic unit 212. In the top view direction TD of the semiconductor device 2, the underfill layer 32 may surround the photonic unit 212 to enhance adhesion between the photonic unit 212 and the coupling member 102. As the underfill layer 32 has good fluidity before curing, the underfill layer 32 may be formed between the coupling member 102 and the photonic unit 212, but it is not limited thereto. The underfill layer 18 in this embodiment may be the same as that described in the above embodiment, so it will not be described in detail herein. Subsequently, the optical fiber 14 may be disposed in the second recess R2, and the optical fiber 14 may be fixed in the second recess R2 through the adhesive 22, thereby forming the semiconductor device 2 in this embodiment. Since other steps of the manufacturing method in this embodiment may be the same as or similar to those in the above embodiment, they are not described in detail herein.

To sum up, in the semiconductor device according to the present disclosure, the coupling member may have the second recess for confining the position of the optical fiber. Furthermore, the depth of the second recess may be greater than or equal to half the diameter of the optical fiber, so that the optical fiber may be easily confined in the second recess, thereby reducing optical loss between the photonic unit and the optical fiber. Moreover, the photonic unit may be disposed in the first recess of the coupling member, so that the chip unit may be electrically connected to the photonic unit through the coupling member, thereby reducing the size of the whole photonic system. Accordingly, the power consumption of the semiconductor device may be lowered, and/or the operation efficiency of the semiconductor device may be improved.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A semiconductor device, comprising:
a substrate structure comprising a coupling member;
a photonic unit disposed in a first recess of the coupling member;
an optical fiber disposed in a second recess of the coupling member and optically coupled to the photonic unit; and
a chip unit disposed on the substrate structure and electrically connected to the photonic unit through the coupling member,
wherein a depth of the second recess is greater than or equal to half a diameter of the optical fiber.

2. The semiconductor device as claimed in claim 1, wherein the optical fiber comprises a core portion and a cladding portion, and the cladding portion surrounds the core portion.

3. The semiconductor device as claimed in claim 1, wherein the substrate structure further comprises a substrate, and the coupling member is disposed on an upper surface of the substrate and comprises a first insulating layer and a second insulating layer, wherein the first insulating layer is disposed on the substrate, the second insulating layer is disposed on the first insulating layer, and a thickness of the first insulating layer is less than a thickness of the second insulating layer.

4. The semiconductor device as claimed in claim 3, wherein the substrate structure further comprises:
a though hole penetrating through the substrate;
a conductive element disposed in the though hole; and
another coupling member disposed on a lower surface of the substrate away from the upper surface,
wherein the conductive element is electrically connected to the coupling member and the another coupling member.

5. The semiconductor device as claimed in claim 4, wherein a roughness of a sidewall of the though hole differs from a roughness of the upper surface of the substrate.

6. The semiconductor device as claimed in claim 4, wherein the first insulating layer comprises a first sidewall facing the second recess and a first lower surface facing the substrate, the second insulating layer comprises a second sidewall facing the second recess and a second lower surface facing the first insulating layer, and an angle between the first sidewall and the first lower surface is less than an angle between the second sidewall and the second lower surface.

7. The semiconductor device as claimed in claim 4, wherein the another coupling member comprises a bonding pad, and the bonding pad has a recessed surface.

8. The semiconductor device as claimed in claim 3, wherein the substrate comprises glass.

9. The semiconductor device as claimed in claim 1, wherein in a cross-sectional view of the semiconductor device, a number of contact points of the optical fiber with the substrate structure is greater than three.

10. The semiconductor device as claimed in claim 1, wherein the photonic unit comprises a photoelectric element and a waveguide element, and the optical fiber is optically coupled to the waveguide element.

11. A manufacturing method of a semiconductor device, comprising:
forming a substrate structure and a photonic unit, wherein the substrate structure comprises a coupling member, and the photonic unit is disposed in a first recess of the coupling member;
disposing a chip unit on the substrate structure, wherein the chip unit is electrically connected to the photonic unit through the coupling member; and
disposing an optical fiber in a second recess of the coupling member, wherein the optical fiber is optically coupled to the photonic unit,
wherein a depth of the second recess is greater than or equal to half a diameter of the optical fiber.

12. The manufacturing method of the semiconductor device as claimed in claim 11, wherein forming the substrate structure comprises providing a substrate and forming the coupling member on an upper surface of the substrate.

13. The manufacturing method of the semiconductor device as claimed in claim 12, wherein forming the photonic unit comprises forming a photoelectric element on the substrate before forming the coupling member, and forming a waveguide element on the photoelectric element.

14. The manufacturing method of the semiconductor device as claimed in claim 12, wherein the substrate comprises glass.

15. The manufacturing method of the semiconductor device as claimed in claim 12, wherein forming the coupling member comprises forming a first insulating layer on the substrate and forming a second insulating layer on the first insulating layer, wherein a thickness of the first insulating layer is less than a thickness of the second insulating layer.

16. The manufacturing method of the semiconductor device as claimed in claim 15, wherein the first insulating layer comprises a first sidewall facing the second recess and a first lower surface facing the substrate, the second insulating layer comprises a second sidewall facing the second recess and a second lower surface facing the first insulating layer, and an angle between the first sidewall and the first lower surface is less than an angle between the second sidewall and the second lower surface.

17. The manufacturing method of the semiconductor device as claimed in claim 15, wherein the first insulating layer comprises a first opening, the second insulating layer comprises a second opening, and the first opening and the second opening form the second recess.

18. The manufacturing method of the semiconductor device as claimed in claim 12, wherein forming the substrate structure further comprises forming another coupling member on a lower surface of the substrate away from the upper surface, wherein the substrate structure further comprises at least one conductive element electrically connected to the coupling member and the another coupling member.

19. The manufacturing method of the semiconductor device as claimed in claim 11, wherein in a cross-sectional view of the semiconductor device, a number of contact points of the optical fiber with the substrate structure is greater than three.

20. The manufacturing method of the semiconductor device as claimed in claim 11, wherein the optical fiber comprises a core portion and a cladding portion, and the cladding portion surrounds the core portion.
